(19) United States
(12) Patent Application Publication
(10) Pub. No.: US 2025/0037155 A1
(43) Pub. Date: Jan. 30, 2025

(54) DEEP LEARNING MODEL BASED METHOD FOR FORECASTING ONLINE RIDE-HAILING SHORT-TERM DEMAND

(71) Applicant: Beijing University of Chemical Technology, Beijing (CN)

(72) Inventors: Xiang LI, Beijing (CN); Jingyi LI, Beijing (CN); Kun JIN, Beijing (CN); Hongguang MA, Beijing (CN)

(73) Assignee: Beijing University of Chemical Technology, Beijing (CN)

(21) Appl. No.: 18/523,982

(22) Filed: Nov. 30, 2023

(30) Foreign Application Priority Data
Jul. 27, 2023 (CN) 202310930943.3

(51) Int. Cl. G06Q 30/0202

(52) U.S. Cl. CPC G06Q 30/0202

(57) ABSTRACT

A deep learning model based method for forecasting online ride-hailing short-term demand is provided. The deep learning model based method includes S1: collecting online ride-hailing demand data in a large transportation hub, and preprocessing original data, to form a data set; S2: performing time series decomposition, specifically, decomposing time series data processed in S1 through a variational modal decomposition (VMD) method, to obtain the certain number of intrinsic mode functions; S3: forecasting a decomposed model by means of a deep learning model Transformer; S4: performing sub-series integration, specifically, accumulating forecast results in S3, to obtain an integrated forecast result; and S5: performing forecast error correction, specifically, correcting a forecast error by using a time series forecast model, that is, an autoregressive integrated moving average model (ARIMA).

### CROSS REFERENCE TO THE RELATED APPLICATIONS

This application is based upon and claims priority to Chinese Patent Application No. 202310930943.3, filed on Jul. 27, 2023, the entire contents of which are incorporated herein by reference.

### TECHNICAL FIELD

The present invention relates to the field of forecasting of online ride-hailing demand and machine learning, and particularly relates to a deep learning model based method for forecasting online ride-hailing short-term demand.

### BACKGROUND

With the development of the mobile Internet and the intelligent transportation system, online ride-hailing, as an emerging mode of travel that connects passengers and drivers through online platforms and mobile terminals, has become one of the major ways for residents to travel. Before the emergence of online ride-hailing, the main means of travel for residents includes private cars, cruising cabs, buses, subways, etc., but there are shortcomings such as license plate number restrictions, high prices, congestion, untimely matching of supply and demand, and poor travel experience. Online ride-hailing has made up for the shortcomings of the traditional modes of travel, and the proportion of online ride-hailing travel in the travel modes of residents has been rising year by year owing to its advantages of matching demand in real time, comfort and convenience, and affordability. A service process of online ride-hailing is that a passenger with a mobile terminal places an order on an APP platform, and the platform receives the order information and then matches the passenger with a suitable vehicle to deliver the passenger to the destination. In this process, forecasting of online ride-hailing demand is crucial, otherwise there will be an imbalance between supply and demand, with oversupply leading to higher costs of idling vehicles and undersupply leading to unmet passenger demand.

### SUMMARY

An objective of the present invention is to provide a deep learning model based method for forecasting online ride-hailing short-term demand. By adding decomposition integration and error correction links, the forecast performance of an online ride-hailing short-term demand forecast model is improved, such that reliable decision-making basis is provided for scheduling and operation of online ride-hailing in an urban transportation hub.
in order to achieve the above objective, the present invention provides a deep learning model based method for forecasting online ride-hailing short-term demand, including:
S1: performing data collection and preprocessing, specifically, collecting online ride-hailing demand data in a large transportation hub, and preprocessing original data, to form a data set;
S2: performing time series decomposition, specifically, decomposing time series data processed in S1 through a variational modal decomposition (VMD) method, to obtain the certain number of intrinsic mode functions, and decomposing an original series of a non-stationary series into a plurality of stationary sub-series;
S3: performing forecasting of online ride-hailing demand, specifically, forecasting a decomposed model by means of a deep learning model Transformer;
S4: performing sub-series integration, specifically, accumulating forecast results in S3, to obtain an integrated forecast result; and
S5: performing forecast error correction, specifically, correcting a forecast error by using a time series forecast model, that is, the autoregressive integrated moving average model (ARIMA).

Preferably, in S1, mean interpolation is performed on missing data, and outliers are smoothed to obtain a complete data set for analysis.

Preferably, in S2, an implementation method for the variational modal decomposition method specifically includes:
S21: initializing {ûₖ¹}, {ω̅ₖ¹}, and \hat{λ}¹, where {ûₖ¹} and {\hat{ω}ₖ¹} represent a k th mode function and center frequency respectively, \hat{λ}¹ is a Lagrangian operator, and the number 1 in an upper right corner represents the first iteration;
S22: continuously updating each sub-series to obtain ûₖⁿ⁺¹(ω) and ωₖⁿ⁺¹,

$${\hat{u}}_{k}^{n + 1} ( \text{'} v ) = \frac{\hat{f} ( ω ) - {\sum }_{i} {\hat{u}}_{i} ( ω ) + \frac{\hat{λ} ( ω )}{2}}{1 + 2 {α ( ω - {ω}_{k} )}^{2}}$$

$${ω}_{k}^{n + 1} = \frac{{\int }_{0}^{∞} ω {\vert {\hat{u}}_{k} ( ω ) \vert}^{2} d ω}{{\int }_{0}^{∞} {\vert {\hat{u}}_{k} ( ω ) \vert}^{2} d ω}$$

where in the formulas, ûₖⁿ⁺¹(ω) is Wiener filtering of a current residual function, ωₖⁿ⁺¹ is a frequency center of a corresponding mode function, and ω is a frequency value; and \hat{f}(ω) and \hat{λ}(ω) represent Fourier transforms of original series f(t) and \hat{ω}ₖ respectively, and α is a quadratic penalty factor;
S23: ω≥0, and updating \hat{λ}ⁿ⁺¹;

$${\hat{λ}}^{n + 1} ( ω ) = {\hat{λ}}^{n} ( ω ) + τ ( \hat{f} ( ω ) - {\sum }_{k}^{K} {\hat{u}}_{k}^{n + 1} )$$

where τ represents a noise tolerance, and K represents the total number of modes; and
S24: determining an iteration termination condition;

$${\sum }_{k = 1} {‖ {\hat{u}}_{k}^{n + 1} - {\hat{u}}_{k}^{n} ‖}_{2}^{2} / {‖ {\hat{u}}_{k}^{n} ‖}_{2}^{2} < ε$$

under the condition that the condition is satisfied, terminating iteration, to obtain K decomposed sub-series, where ε represents a similarity coefficient; and under the condition that the condition is unsatisfied, repeating S21-S24.

Preferably, in S3, the forecasting a decomposed model by means of a deep learning model Transformer includes:
S31: encoding input information, where input of the Transformer model is obtained by adding word embedding and position embedding, position information is obtained by position encoding, and a position encoding formula is as follows:

$${PE}_{( p o s , 2 i )} = sin ( pos / {( 2 {L}_{x} )}^{2 i / {d}_{m o d e l}} )$$

$${PE}_{( p o s , 2 i + 1 )} = cos ( pos / {( 2 {L}_{x} )}^{2 i / {d}_{m o d e l}} )$$

where PE represents Position Embedding, pos represents a position of a single data, d_{model} represents an encoding dimension, 2i represents an even dimension, and 2i+1 represents an odd dimension;
S32: entering an encoder module, where an encoding block is formed by stacking L_{enc} independent encoding layers, each encoding layer includes a multi-head attention layer, a fully-connected layer and a regularization layer, and multi-head attention of a decoding layer is expressed as:

$$Multihead ( H ) = concat ( {head}_{1} , … , {head}_{u} ) {W}^{O}$$

a calculation process is that U attention representations are spliced and then are subject to matrix multiplication with W^{O}, and a single attention block is a function of Q, K and V in combination with a formula as follows:

$${head}_{i} = softmax ( \frac{Q {K}^{T}}{\sqrt{{d}_{k}}} V )$$

in the formula: QϵR^{nd}^{ₖ}; KϵR^{nd}^{ₖ}; and VϵR^{nd}^{ᵥ}, where Q, K, and V are obtained by encoding input data and then performing linear mapping again:

$$\begin{matrix}Q = X {W}^{Q} \\ K = X {W}^{K} \\ V = X {W}^{V}\end{matrix}$$

in the formulas: W^{Q}, W^{K}, and W^{V} are learnable parameters; and X is a feature matrix obtained by combining the input data with position encoding, and Xₜ is defined as:

$${X}_{t} = {X}_{t} + {e}_{t}$$

where n input data are provided, and each input item XₜϵR^{1×d} is a d dimension vector

S33: defining that the decoding layer includes two multi-head attention layers, where the first attention layer is the same as the attention layer of the decoding layer; K and V of the second attention layer are outputs of the decoding block, and Q is output of the regularization layer; and

$${norm}_{cur} = Normalization ( 𝓏 , {norm}_{pre} )$$

z is output of the attention layer or the fully-connected layer, the regularization layer in Transformer has the same structure and is composed of skip connection and regularization operation.

Preferably, in S5, error correction is performed on the forecast result as follows:
S51: performing a stationarity test on a difference series between the forecast result of online ride-hailing order demand output by the deep learning model and the original data, and performing differential processing on non-stationary data, and using differenced stationary data as an original input series of the ARIMA model;
S52: performing a white noise test on the data, to determine whether the series is a random series;
S53: determining a difference order d for a differenced stationary series, calculating an autocorrelation coefficient (ACF) and a partial autocorrelation coefficient (PACF), where an ACF function calculation formula is as follows:

$$ACF ( k ) = {ρ}_{k} = \frac{Cov ( {y}_{t} , {y}_{t - k} )}{Var ( {y}_{t} )}$$

drawing an image for observation, and determining parameters p,d,q of the ARIMA model by an Akaike information criterion (AIC) and Bayesian information criterion (BIC);
S54: determining an optimal parameter of the model after performing the stationarity test and the differential processing on the series, to obtain an error forecast result of the ARIMA model; and
S55: adding the error forecast result of the ARIMA model to the forecast result of the deep learning model, to obtain a final forecast value of the online ride-hailing demand.

Therefore, the present invention uses the above-mentioned deep learning model based method for forecasting online ride-hailing short-term demand, which has the following beneficial effects: by adding decomposition integration and error correction links, the forecast performance of an online ride-hailing short-term demand forecast model is improved, such that reliable decision-making basis is provided for scheduling and operation of online ride-hailing in an urban transportation hub.

The technical solution of the present invention will be further described in detail by means of the accompanying drawings and examples.

### BRIEF DESCRIPTION OF THE DRAWINGS

FIG. 1 is a flowchart of a deep learning model based method for forecasting online ride-hailing short-term demand according to the present invention;

FIG. 2 is a schematic diagram of a deep learning model Transformer according to the present invention;

FIG. 3 is a flowchart of an error correction model that is, an autoregressive integrated moving average model (ARIMA) according to the present invention; and

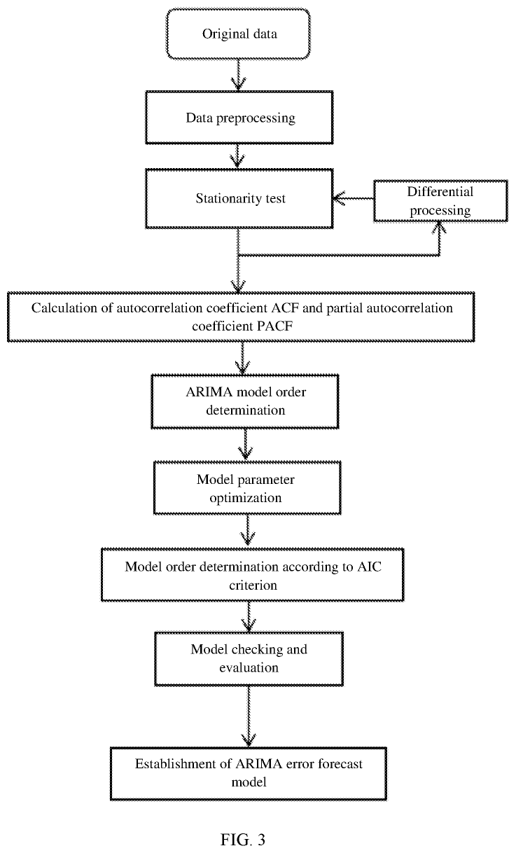

FIG. 4 is a diagram illustrating an example of a forecast result of online ride-hailing demand according to the present invention.

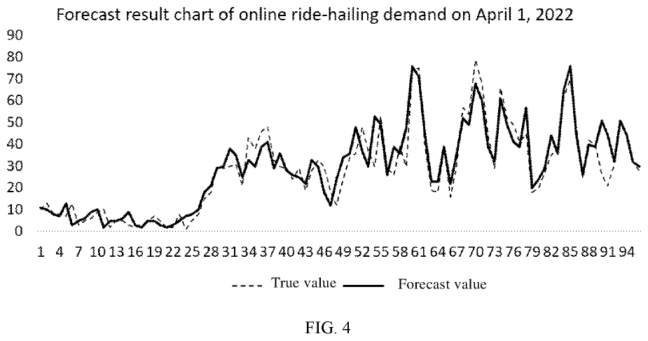

### DETAILED DESCRIPTION OF THE EMBODIMENTS

The technical solution of the present invention will be further elaborated hereafter in conjunction with accompanying drawings and examples.

Unless otherwise defined, technical or scientific terms used in the present invention are to be given their ordinary meaning as understood by those of ordinary skill in the art to which the present invention belongs.

Words “comprise” or “include” and the like used in the present invention mean that the elements listed before the word cover the elements listed after the word, and do not exclude the possibility of also covering other elements. Terms “inner”, “outer”, “upper”, “lower”, etc. indicate azimuthal or positional relations based on those shown in the drawings only for ease of description of the present invention and for simplicity of description, and are not intended to indicate or imply that the referenced device or element must have a particular orientation and be constructed and operative in a particular orientation, and thus may not be construed as a limitation on the present invention. When the absolute position of the described object changes, the relative positional relation may also change accordingly. In the present invention, unless otherwise clearly specified, the terms “attach”, etc. should be understood in a board sense. For example, attach may be a fixed connection, a detachable connection, an integral connection, a direct connection, or an indirect connection by using an intermediate medium, or may be intercommunication between two elements, or an interworking relation between two elements. Those of ordinary skill in the art may understand specific meanings of the foregoing terms in the present invention based on a specific situation.

### Example 1

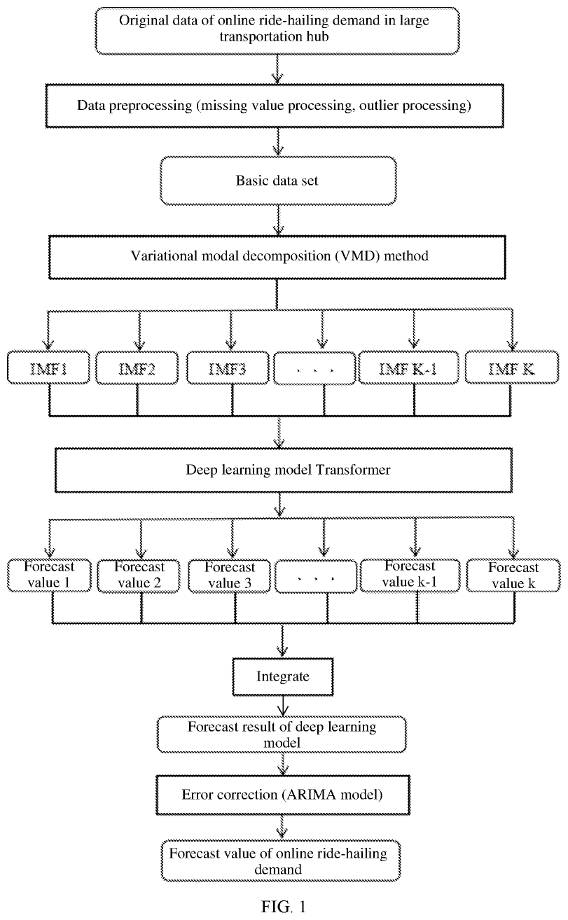

As shown in FIG. 1, the present invention provides a deep learning model based method for forecasting online ride-hailing short-term demand, and adds a decomposition-integration and error correction mechanism. The method includes:
S1: perform data collection and preprocessing, specifically, collect online ride-hailing demand data of a large transportation hub, and preprocess original data, to form a data set. In S1, data preprocessing includes missing value processing and outlier processing.

A time interval of data is 15 min, such a mean interpolation method is used for processing missing values, and a mean value of required quantity in a previous time period and a next time period is taken for filling. A linear interpolation method is used for filling in the missing data when there are more than two missing data.

When the missing values are detected in consecutive time periods, x₀ represents a data value recorded at the time period i=0, x_{I+1} represents a data value recorded at the time period i=I+1, and a formula for filling of the missing values through the linear interpolation method is as follows:

$${x}_{i} = {x}_{0} + \frac{i}{I + 1} \times ( {x}_{I + 1} - {x}_{0} ) , ∀ i = 1 , 2 , … , I$$

A Hampel recognizer is used for processing outliers. A process of Hampel recognition is carried out in a form of sliding window. Median values in the window are calculated one by one, and a median absolute deviation MAD is calculated. All series elements beyond 3 times MAD×κ upper and lower limits are marked as outliers.

S2: perform time series decomposition, specifically, decompose time series data processed in S1 through a variational modal decomposition (VMD) method, to obtain the certain number of intrinsic mode functions, and decompose an original series of a non-stationary series into a plurality of stationary sub-series. In S2, an implementation method for the variational modal decomposition method specifically includes:
S21: initialize {ûₖ¹}, {\hat{ω}ₖ¹}, and \hat{λ}¹, where {ûₖ¹} and {\hat{ω}ₖ¹} represent a k th mode function and center frequency respectively, \hat{λ}¹ is a Lagrangian operator, and the number 1 in an upper right corner represents the first iteration;
S22: continuously update each sub-series to obtain ûₖⁿ⁺¹(ω) and ωₖⁿ⁺¹,

$${\hat{u}}_{k}^{n + 1} ( ω ) = \frac{\hat{f} ( ω ) - {\sum }_{i} {\hat{u}}_{i} ( ω ) + \frac{\hat{λ} ( ω )}{2}}{1 + 2 {α ( ω - {ω}_{k} )}^{2}}$$

$${ω}_{k}^{n + 1} = \frac{{\int }_{0}^{∞} ω {\vert {\hat{u}}_{k} ( ω ) \vert}^{2} d ω}{{\int }_{0}^{∞} {\vert {\hat{u}}_{k} ( ω ) \vert}^{2} d ω}$$

where in the formulas, ûₖⁿ⁺¹(ω) is Wiener filtering of a current residual function, ωₖⁿ⁺¹ is a frequency center of a corresponding mode function, and ω is a frequency value; and \hat{f}(ω) and \hat{λ}(ω) represent Fourier transforms of original series f(t) and \hat{ω}ₖ respectively, and α is a quadratic penalty factor;
S23: ω≥0, and update \hat{λ}ⁿ⁺¹;

$${\hat{λ}}^{n + 1} ( ω ) = {\hat{λ}}^{n} ( ω ) + τ ( \hat{f} ( ω ) - {\sum }_{k}^{K} {\hat{u}}_{k}^{n + 1} )$$

where τ represents a noise tolerance, and K represents the total number of modes; and
S24: determine an iteration termination condition;

$${\sum }_{k = 1} {‖ {\hat{u}}_{k}^{n + 1} - {\hat{u}}_{k}^{n} ‖}_{2}^{2} / {‖ {\hat{u}}_{k}^{n} ‖}_{2}^{2} < ε$$

under the condition that the condition is satisfied, terminate iteration, to obtain K decomposed sub-series, where s represents a similarity coefficient; and under the condition that the condition is unsatisfied, repeat S21-S24.

A premise of VMD is to construct a variational problem. Assuming that each “mode” is a finite bandwidth with a center frequency, the variational problem can be described as finding K intrinsic mode functions (IMF) uₖ(t), to minimize a sum of the estimated bandwidths of each mode, and a constraint is that the sum of each mode is an original input signal. The variational problem is constructed as follows:
(1) Obtain an analytical signal of each mode function by Hilbert transform, to obtain its unilateral spectrum, with specific transformation as follows:

$$( δ ( t ) + \frac{j}{π t} ) ⋆ {u}_{k} ( t ) ,$$

where

δ(t) is a pulse signal function, uₖ(t) is an IMF, and * is a convolution calculation symbol, and j represents an imaginary unit.

(2) Add an estimated center frequency e^{-jω}^{ₖ}^{t} to the analytical signal of each mode with a formula as follows:

$$[ ( δ ( t ) + \frac{j}{π t} ) ⋆ {u}_{k} ( t ) ] {e}^{- j {ω}_{k} t} ,$$

where is ωₖ the center frequency, and a spectrum of each mode can be modulated to a corresponding fundamental frequency band.
(3) Calculate a square L2 norm of the gradient of the above demodulated signal, estimate each modal signal bandwidth, and construct a variational problem that minimizes a total modal signal bandwidth, where the variational problem is expressed as follows:

$${min}_{\{ {u}_{k} \} , \{ {ω}_{k} \}} \{ {\sum }_{k} {‖ {\partial }_{t} [ ( δ ( t ) + \frac{j}{π t} ) ⋆ {u}_{k} ( t ) ] {e}^{- j {ω}_{k} t} ‖}^{2} \} s . t . {\sum }_{k} {u}_{k} ( t ) = f ( t )$$

where f is the original signal f(t), ∂ₜ represent the derivative with respect to time, and t is time.

An algorithm of variational modal decomposition obtains an extended Lagrangian expression by introducing a penalty factor α and a Lagrangian multiplier λ(t) as follows:

$$L ( \{ {u}_{k} \} , \{ {ω}_{k} \} , λ ) : α {\sum }_{k} {‖ {\partial }_{t} [ ( δ ( t ) + \frac{j}{π t} ) ⋆ {u}_{k} ( t ) ] {e}^{- j {ω}_{k} t} ‖}_{2}^{2} + {‖ f ( t ) - {\sum }_{k} {u}_{k} ( t ) ‖}_{2}^{2}$$

f(t) is the original signal.
S3: perform forecasting of online ride-hailing demand, specifically, forecast a decomposed model by means of a deep learning model Transformer. A Transformer multivariable time series forecast model is based on an original Transformer architecture, and a main structure is based on an encoder-decoder architecture. An encoder converts an input series (x₁, . . . , xₙ) into a continuous expression (z₁, . . . , zₙ), and finally a decoder generates an output series (y₁, . . . , yₘ). Encoding and decoding portions are stacked by 6 encoder and decoder modules respectively, and each layer has the same structure.

In the encode, each layer includes a multi-head attention mechanism layer and a fully-connected feed-forward neural network layer. skip connection and normalization processes are connected after each sub-layer, and output of each sub-layer is LayerNorm(x+Sublayer(x)) A structure of the decoder is similar to that of the encoder. The decoder is additionally provided with a Masked Multi-head self-attention structure, to performing decoding in order, and the current output can only be based on an output part.

In S3, the step of forecasting a decomposed model by means of a deep learning model Transformer includes:
S31: encode input information, where input of the Transformer model is obtained by adding word embedding and position embedding, position information is obtained by position encoding, and a position encoding formula is as follows:

$${PE}_{( p o s , 2 i )} = sin ( pos / {( 2 {L}_{x} )}^{2 i / {d}_{model}} )$$

$${PE}_{( p o s , 2 i + 1 )} = cos ( pos / {( 2 {L}_{x} )}^{2 i / {d}_{model}} )$$

where PE represents Position Embedding, pos represents a position of a single data, d_{model} represents an encoding dimension, 2i represents an even dimension, and 2i+1 represents an odd dimension;
S32: enter an encoder module, where an encoding block is formed by stacking L_{enc} independent encoding layers, each encoding layer includes a multi-head attention layer, a fully-connected layer and a regularization layer, and multi-head attention of a decoding layer is expressed as:

$$Multihead ( H ) = concat ( {head}_{1} , … , {head}_{u} ) {W}^{O}$$

A calculation process is that u attention representations are spliced and then are subject to matrix multiplication with W^{O}, and a single attention block is a function of Q, K and V in combination with a formula. The Transformer model uses the multi-head attention mechanism, and the multi-head attention mechanism is composed of a plurality of Scaled Dot-Product Attention. Input of the module includes three vectors, that is, Query, Key and Value, which are represented by Q, K and V respectively. The three vectors are calculated based on an input vector. Dimensions of Query and Key are dₖ, and a dimension of Value is dᵥ. A calculation formula is as follows:

$$Attention ( Q , K , V ) = softmax ( \frac{Q {K}^{T}}{\sqrt{{d}_{k}}} ) V$$

Q, K and V respectively represent three vectors of Query, Key and Value, and the three vectors are calculated based on the input vector. A dot product of the vectors Q and K is calculated first, and is divided by \sqrt{dₖ}, and a corresponding weight is obtained through a softmax function, and then the dot product is weighted with the vector V.

$${head}_{i} = soft max ( \frac{{QK}^{T}}{\sqrt{{d}_{k}}} V )$$

the formula: QϵR^{nd}^{ₖ}; KϵR^{nd}^{ₖ}; and VϵR^{nd}^{ᵥ}, where Q, K, and V are obtained by encoding input data and then performing linear mapping again:

$$Q = {XW}^{Q}$$

$$K = {XW}^{K}$$

$$V = {XW}^{V}$$

in the formulas: W^{Q}, W^{K}, and W^{V} are learnable parameters; and X is a feature matrix obtained by combining the input data with position encoding, and Xₜ is defined as:

$${X}_{t} = {X}_{t} + {e}_{t}$$

where n input data are provided, and each input item XₜϵR^{1×d} is a d dimension vector; and
S33: define that the decoding layer includes two multi-head attention layers, where the first attention layer is the same as the attention layer of the decoding layer; K and V of the second attention layer is output of the decoding block, and Q is output of the regularization layer; and

$${norm}_{cur} = Normalization ( z , {norm}_{pre} )$$

Z is output of the attention layer or the fully-connected layer, the regularization layer in Transformer has the same structure and is composed of skip connection and regularization operation.
S4: perform sub-series integration, specifically, accumulate forecast results in S3, to obtain an integrated forecast result; and
S5: perform forecast error correction, specifically, corrected a forecast error by using a time series forecast model, that is, an autoregressive integrated moving average model (ARIMA).

In S5, error correction is performed on the forecast result as follows:
S51: performed a stationarity test on a difference series between the forecast result of online ride-hailing order demand output by the deep learning model and the original data, perform differential processing on non-stationary data, and use differenced stationary data as an original input series of the ARIMA model;
S52: perform a white noise test on the data, to determine whether the series is a random series;
S53: determine a difference order d for a differenced stationary series, calculate an autocorrelation coefficient (ACF) and a partial autocorrelation coefficient (PACF), where an ACF function calculation formula is as follows:

$$ACF ( k ) = {ρ}_{k} = \frac{Cov ( {y}_{t} , {y}_{t - k} )}{Var ( {y}_{t} )}$$

draw an image for observation, and determine parameters p, d, q of the ARIMA model by an Akaike information criterion (AIC) and Bayesian information criterion (BIC);
S54: determine an optimal parameter of the model after performing the stationarity test and the differential processing on the series, to obtain an error forecast result of the ARIMA model; and
S55: add the error forecast result of the ARIMA model to the forecast result of the deep learning model, to obtain a final forecast value of the online ride-hailing demand.

Therefore, by using the deep learning forecast model for online ride-hailing demand with the decomposition-integration and error correction mechanism, the online ride-hailing short-term demand quantity in an urban large transportation hub in the next 15 min can be accurately forecast, and a reliable decision-making basis is provided for scheduling of online ride-hailing.

### Example 2

Position is Beijing West Railway Station, a time span is from Apr. 1, 2022 to Jul. 31, 2022, a time interval is 15 min, and there are 11712 data in total. An example of preprocessed data is shown in Table 1:

TABLE 1
Preprocessed online ride-hailing demand data

| Time | Online ride-hailing demand |
|---|---|
| 2022 Apr. 1 0:00 | 10 |
| 2022 Apr. 1 0:15 | 13 |
| 2022 Apr. 1 0:30 | 8 |
| 2022 Apr. 1 0:45 | 8 |
| 2022 Apr. 1 1:00 | 7 |
| 2022 Apr. 1 1:15 | 13 |
| 2022 Apr. 1 1:30 | 3 |
| 2022 Apr. 1 1:45 | 5 |
| 2022 Apr. 1 2:00 | 6 |
| 2022 Apr. 1 2:15 | 9 |
| 2022 Apr. 1 2:30 | 10 |
| 2022 Apr. 1 2:45 | 2 |
| 2022 Apr. 1 3:00 | 5 |
| 2022 Apr. 1 3:15 | 5 |
| 2022 Apr. 1 3:30 | 3 |
| 2022 Apr. 1 3:45 | 2 |
| 2022 Apr. 1 4:00 | 3 |
| 2022 Apr. 1 4:15 | 5 |
| 2022 Apr. 1 4:30 | 7 |
| 2022 Apr. 1 4:45 | 5 |
| 2022 Apr. 1 5:00 | 2 |
| 2022 Apr. 1 5:15 | 2 |
| 2022 Apr. 1 5:30 | 8 |
| 2022 Apr. 1 5:45 | 1 |
| 2022 Apr. 1 6:00 | 5 |
| 2022 Apr. 1 6:15 | 8 |
| 2022 Apr. 1 6:30 | 15 |
| 2022 Apr. 1 6:45 | 18 |
| 2022 Apr. 1 7:00 | 30 |
| 2022 Apr. 1 7:15 | 29 |
| 2022 Apr. 1 7:30 | 30 |
| 2022 Apr. 1 7:45 | 31 |
| 2022 Apr. 1 8:00 | 21 |
| 2022 Apr. 1 8:15 | 43 |
| 2022 Apr. 1 8:30 | 38 |
| 2022 Apr. 1 8:45 | 46 |
| 2022 Apr. 1 9:00 | 48 |
| 2022 Apr. 1 9:15 | 33 |
| 2022 Apr. 1 9:30 | 30 |
| 2022 Apr. 1 9:45 | 29 |
| 2022 Apr. 1 10:00 | 24 |
| 2022 Apr. 1 10:15 | 29 |
| 2022 Apr. 1 10:30 | 19 |
| 2022 Apr. 1 10:45 | 28 |
| 2022 Apr. 1 11:00 | 33 |
| 2022 Apr. 1 11:15 | 30 |
| 2022 Apr. 1 11:30 | 18 |
| 2022 Apr. 1 11:45 | 12 |
| 2022 Apr. 1 12:00 | 24 |
| 2022 Apr. 1 12:15 | 34 |
| 2022 Apr. 1 12:30 | 36 |
| 2022 Apr. 1 12:45 | 48 |
| 2022 Apr. 1 13:00 | 37 |
| 2022 Apr. 1 13:15 | 30 |
| 2022 Apr. 1 13:30 | 53 |
| 2022 Apr. 1 13:45 | 29 |
| 2022 Apr. 1 14:00 | 26 |
| 2022 Apr. 1 14:15 | 39 |
| 2022 Apr. 1 14:30 | 30 |
| 2022 Apr. 1 14:45 | 74 |
| 2022 Apr. 1 15:00 | 75 |
| 2022 Apr. 1 15:15 | 40 |
| 2022 Apr. 1 15:30 | 19 |
| 2022 Apr. 1 15:45 | 18 |
| 2022 Apr. 1 16:00 | 39 |
| 2022 Apr. 1 16:15 | 16 |
| 2022 Apr. 1 16:30 | 30 |
| 2022 Apr. 1 16:45 | 57 |
| 2022 Apr. 1 17:00 | 54 |
| 2022 Apr. 1 17:15 | 79 |
| 2022 Apr. 1 17:30 | 68 |
| 2022 Apr. 1 17:45 | 44 |
| 2022 Apr. 1 18:00 | 29 |
| 2022 Apr. 1 18:15 | 66 |
| 2022 Apr. 1 18:30 | 52 |
| 2022 Apr. 1 18:45 | 49 |
| 2022 Apr. 1 19:00 | 41 |
| 2022 Apr. 1 19:15 | 45 |
| 2022 Apr. 1 19:30 | 18 |
| 2022 Apr. 1 19:45 | 20 |
| 2022 Apr. 1 20:00 | 27 |
| 2022 Apr. 1 20:15 | 35 |
| 2022 Apr. 1 20:30 | 38 |
| 2022 Apr. 1 20:45 | 62 |
| 2022 Apr. 1 21:00 | 70 |
| 2022 Apr. 1 21:15 | 49 |
| 2022 Apr. 1 21:30 | 25 |
| 2022 Apr. 1 21:45 | 42 |
| 2022 Apr. 1 22:00 | 40 |
| 2022 Apr. 1 22:15 | 26 |
| 2022 Apr. 1 22:30 | 21 |
| 2022 Apr. 1 22:45 | 31 |
| 2022 Apr. 1 23:00 | 51 |
| 2022 Apr. 1 23:15 | 44 |
| 2022 Apr. 1 23:30 | 32 |
| 2022 Apr. 1 23:45 | 28 |

For the data set in Table 1, the proposed deep learning forecast model with the addition of decomposition-integration and error correction mechanism is validated.

Specific operation is as follows:

In S1, include missing value processing and outlier processing, where a time interval of data is 15 min, and the time interval is short, such that a mean interpolation method is used for processing one missing value, and a mean value of required quantity in a previous time period and a next time period is taken for filling. A linear interpolation method is used for filling in the missing data when there are more than two missing data. Assuming that the missing values are detected in consecutive time periods, x₀ represents a data value recorded at the time period i=0, x_{I+1} represents a data value recorded at the time period i=I+1, and a formula for filling of the missing values through the linear interpolation method is as follows:

$${x}_{i} = {x}_{0} + \frac{i}{I + 1} \times ( {x}_{I + 1} - {x}_{0} ) ,$$

$$∀ i = 1 , 2 , … , I$$

As for outlier processing, a Hampel recognizer is used. A process of Hampel recognition is carried out in a form of sliding window. Median values in the window are calculated one by one, and a median absolute deviation MAD is calculated. All series elements beyond 3 times MAD×κ upper and lower limits are marked as outliers.

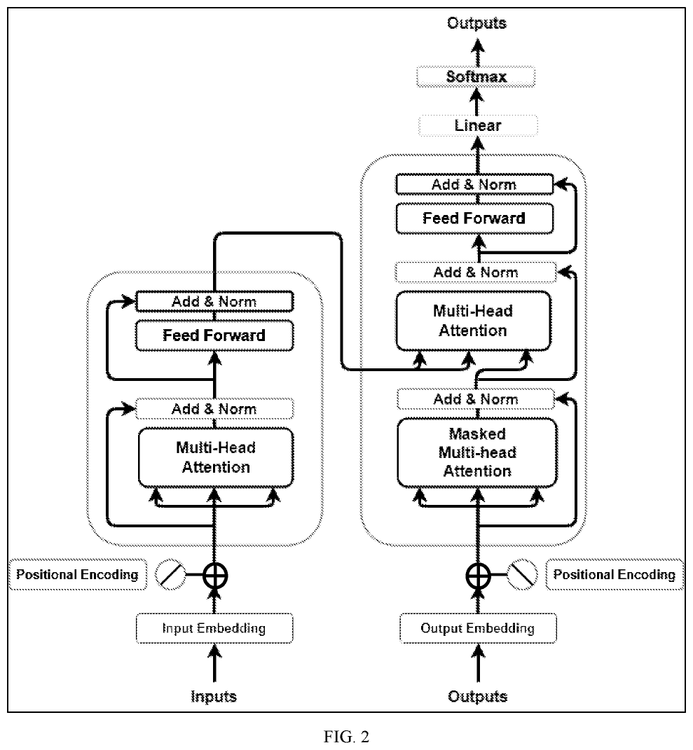

S2 is mainly a process of series decomposition. The VMD decomposes the time series after preprocessing into a plurality of IMFs, as shown in FIG. 2. VMD is a self-adaptive and completely non-recursive mode variation and signal processing method, which has the advantage of determining the number of mode decompositions. The self-adaptability is manifested in determining the number of mode decompositions of a given series according to an actual situation, adaptively matching a center frequency and a limited bandwidth of each mode in a subsequent search and solution process, and implementing effective separation of IMF and frequency domain division of signals, so as to obtain effective decomposition components of a given signal. Finally, an optimal solution of the variational problem is obtained.

In the process of variational modal decomposition, since the number of decomposition needs to be customized, the following steps are used for determining the number of VMD decomposition: firstly, perform decomposition into two IMFs, and then determine a trend item, that is, whether the first IMF has only extreme points, if yes, stop decomposition, if not, continue to perform decomposition into three IMFs, and so on, until the trend item satisfies requirements.

In S3, forecast a series decomposed in S2 by means of a deep learning Transformer. The Transformer is a model consisting of an encoder and a decoder. Firstly, word embedding and position encoding are performed on an input series, and input of the model is obtained after the encoding is superimposed. Calculation is performed by the multi-head attention mechanism and the feed forward neural network mechanism. Finally, a forecast result is output by a Softmax function.

In S4, accumulate and integrate the forecast results in S3, to obtain a forecast result of the deep learning model.

Finally, in S5, use the ARIMA model to correct an error series, and superimpose the error series with an original forecast result, to obtaining a final demand forecast result.

Therefore, the present invention uses the above-mentioned deep learning model based method for forecasting online ride-hailing short-term demand. By adding decomposition integration and error correction links, the forecast performance of an online ride-hailing short-term demand forecast model is improved, such that reliable decision-making basis is provided for scheduling and operation of online ride-hailing in an urban transportation hub.

Finally, it should be noted that the above examples are merely intended to illustrate the technical solution of the present invention and not to limit the same. Although the present invention has been described in detail with reference to the preferred examples, it should be understood by those of ordinary skill in the art that they may still make modifications or equivalent replacements to the technical solutions of the present invention, and the modification or equivalent replacements does not make the modified technical solutions deviate from the spirit and scope of the technical solution of the present invention.

What is claimed is:

1. A deep learning model based method for forecasting online ride-hailing short-term demand, comprising:
S1: performing a data collection and a preprocessing, comprising collecting online ride-hailing demand data in a large transportation hub, and preprocessing original data to form the data set;
S2: performing a time series decomposition, comprising decomposing time series data processed in step S1 through a variational modal decomposition (VMD) method to obtain a predetermined number of intrinsic mode functions, and decomposing an original series of a non-stationary series into a plurality of stationary sub-series;
S3: performing forecasting of an online ride-hailing demand, comprising forecasting a decomposed model by a deep learning model Transformer;
S4: performing a sub-series integration, comprising accumulating forecast results in step S3 to obtain an integrated forecast result; and
S5: performing a forecast error correction, comprising correcting a forecast error by using a time series forecast model, wherein the time series forecast model is an autoregressive integrated moving average model (ARIMA).

2. The deep learning model based method for forecasting the online ride-hailing short-term demand according to claim 1, wherein in step S1, a mean interpolation is performed on missing data, and outliers are smoothed to obtain a complete data set for an analysis.

3. The deep learning model based method for forecasting the online ride-hailing short-term demand according to claim 2, wherein in step S2, an implementation method for the VMD method comprises:
S21: initializing {ûₖ¹}, {\hat{ω}ₖ¹}, and \hat{λ}¹, wherein {ûₖ¹} and {\hat{ω}ₖ¹} represent a k th mode function and a center frequency respectively, \hat{λ}¹ is a Lagrangian operator, and the number 1 in an upper right corner represents a first iteration;
S22: continuously updating each sub-series to obtain ûₖⁿ⁺¹(ω) and ωₖⁿ⁺¹
$${\hat{u}}_{k}^{n + 1} ( ω ) = \frac{\hat{f} ( ω ) - {\sum }_{i} {\hat{u}}_{i} ( ω ) + \frac{\hat{λ} ( ω )}{2}}{1 + 2 {α ( ω - {ω}_{k} )}^{2}}$$
$${ω}_{k}^{n + 1} = \frac{{\int }_{0}^{∞} ω {\vert {\hat{u}}_{k} ( ω ) \vert}^{2} d ω}{{\int }_{0}^{∞} {\vert {\hat{u}}_{k} ( ω ) \vert}^{2} d ω}$$
wherein in the formulas, ûₖⁿ⁺¹(ω) is Wiener filtering of a current residual function, ωₖⁿ⁺¹ is a frequency center of a corresponding mode function, and ω is a frequency value; and \hat{f}(ω) and \hat{λ}(ω) represent Fourier transforms of original series f(t) and \hat{ω}ₖ respectively, and a is a quadratic penalty factor;
S23: ω≥0, and updating \hat{λ}ⁿ⁺¹;
$${\hat{λ}}^{n + 1} ( ω ) = {\hat{λ}}^{n} ( ω ) + τ ( \hat{f} ( ω ) - {\sum }_{k}^{K} {\hat{u}}_{k}^{n + 1} )$$
wherein τ represents a noise tolerance, and K represents a total number of modes; and
S24: determining an iteration termination condition;
$${\sum }_{k = 1} {‖ {\hat{u}}_{k}^{n + 1} - {\hat{u}}_{k}^{n} ‖}_{2}^{2} / {‖ {\hat{u}}_{k}^{n} ‖}_{2}^{2} < ε$$
under a condition that the iteration termination condition is satisfied, terminating an iteration to obtain K decomposed sub-series, wherein s represents a similarity coefficient; and under a condition that the iteration termination condition is unsatisfied, repeating steps S21-S24.

4. The deep learning model based method for forecasting the online ride-hailing short-term demand according to claim 3, wherein in step S3, the step of forecasting the decomposed model by the deep learning model Transformer comprises:
S31: encoding input information, wherein an input of the deep learning model Transformer is obtained by adding a word embedding and a position embedding, position information is obtained by a position encoding, and a position encoding formula is as follows:
$${PE}_{( pos , 2 i )} = sin ( pos / {( 2 {L}_{x} )}^{2 i / {d}_{model}} )$$
$${PE}_{( pos , 2 i + 1 )} = cos ( pos / {( 2 {L}_{x} )}^{2 i / {d}_{model}} )$$
wherein PE represents Position Embedding, pos represents a position of a single data, d_{model} represents an encoding dimension, 2i represents an even dimension, and 2i+1 represents an odd dimension;
S32: entering an encoder module, wherein an encoding block is formed by stacking L_{enc} independent encoding layers, each of the L_{enc} independent encoding layers comprises a multi-head attention layer, a fully-connected layer, and a regularization layer, and a multi-head attention of a decoding layer is expressed as:
$$Multihead ( H ) = concat ( {head}_{1} , … {head}_{u} ) {W}^{O}$$
a calculation process is that u attention representations are spliced and are subject to a matrix multiplication with W^{O}, and a single attention block is a function of Q, K and V in combination with a formula as follows:
$${head}_{i} = soft max ( \frac{{QK}^{T}}{\sqrt{{d}_{k}}} V )$$
in the formula: QϵR^{nd}^{ₖ}; KϵR^{nd}^{ₖ}; and VϵR^{nd}^{ᵥ}, wherein Q, K, and V are obtained by encoding input data and performing a linear mapping again:
$$Q = {XW}^{Q}$$
$$K = {XW}^{K}$$
$$V = {XW}^{V}$$
in the formulas: W^{Q}, W^{K}, and W^{V} are learnable parameters; and X is a feature matrix obtained by combining the input data with the position encoding, and Xₜ is defined as:
$${X}_{t} = {X}_{t} + {e}_{t}$$
wherein n input data are provided, and each input item XₜϵR^{1×d} is a d dimension vector; and
S33: defining that the decoding layer comprises two multi-head attention layers, wherein a first attention layer of the two multi-head attention layers is the same as an attention layer of the decoding layer; K and V of a second attention layer of the two multi-head attention layers is an output of a decoding block, and Q is an output of the regularization layer; and
norm_{cur}=Normalization(z,normₚᵣₑ)
z is an output of the attention layer or the fully-connected layer, the regularization layer in Transformer has a same structure and is composed of a skip connection and a regularization operation.

5. The deep learning model based method for forecasting the online ride-hailing short-term demand according to claim 4, wherein in step S5, the forecast error correction is performed on the forecast result as follows:
S51: performing a stationarity test on a difference series between the forecast result of an online ride-hailing order demand output by the deep learning model and the original data, and performing a differential processing on non-stationary data, and using differenced stationary data as an original input series of the ARIMA model;
S52: performing a white noise test on the original input series to determine whether the original input series is a random series;
S53: determining a difference order d for a differenced stationary series, calculating an autocorrelation coefficient (ACF) and a partial autocorrelation coefficient (PACF), wherein an ACF function calculation formula is as follows:
$$ACF ( k ) = {ρ}_{k} = \frac{Cov ( {y}_{t} , {y}_{t - k} )}{Var ( {y}_{t} )}$$
drawing an image for observation, and determining parameters p,d,q of the ARIMA model by an Akaike information criterion (AIC) and a Bayesian information criterion (BIC);
S54: determining an optimal parameter of the ARIMA model via the methods introduced in step S53 after performing the stationarity test and the differential processing on the original input series, to obtain an error forecast result of the ARIMA model; and
S55: adding the error forecast result of the ARIMA model to the forecast result of the deep learning model to obtain a final forecast value of the online ride-hailing demand.
